(19) United States
(12) Patent Application Publication
(10) Pub. No.: US 2010/0327595 A1
(43) Pub. Date: Dec. 30, 2010

(54) WAVE POWER GENERATOR

(76) Inventor: Stefan Göttler, Munchen (DE)

Correspondence Address: WOODLING, KROST AND RUST, 9213 CHILLICOTHE ROAD, KIRTLAND, OH, 44094, US

(21) Appl. No.: 12/865,723

(22) PCT Filed: Feb. 5, 2009
(86) PCT No.: PCT/DE2009/000154

§ 371 Date: Sep. 1, 2010

(30) Foreign Application Priority Data
Feb. 7, 2008 (DE) 10 2008 007 938.3
Jun. 20, 2008 (DE) 10 2008 030 047.0
Dec. 23, 2008 (DE) PCT/DE2008/002116

(51) Int. Cl. F03B 13/18

(52) U.S. Cl. 290/53

(57) ABSTRACT

The invention relates to a device for generating electricity from the force of waves, comprising a first floating component (14, 76), a second stationary component (22, 90), at least one generator (18), at least one translational element (12), and at least one rotational element (16). The first floating component (14, 76) and the second stationary component (22, 90) can be translationally moved relative to each other by means of the waves, thus causing a translational relative movement between the translational element (12) and the associated rotational element (16) such that the rotational element (16) absorbs rotational energy which is converted into electricity by means of at least one associated generator (18).

The invention relates to a wave power generator unit for generating electrical energy through the upstroke of a floating body caused by a wave.

Besides wind turbines, solar cells or tidal power plants, it is known to use the movement of the waves. This lends itself in particular near the coast since the waves are largest there.

The WO 2008116621 A1 discloses a device for retrieving energy out of the force of waves. Therein, the upstroke of a movable part, a secondary coil, with respect to a non-movable part in the shape of a primary coil is carried out by the wave. By means of this linear generator, power is generated by means of the relative movement of the primary coil with respect to the secondary coil. The windings of the secondary coil consist, therein, out of a high temperature super conductor. This embodiment has the deficiency that no mechanical storage of energy is possible and the production costs are very high because of the choice in material.

In general, the high production costs and the cost-effectiveness for power generator plants are decisive for their usage.

Therefore, the invention is based on the object to provide a device which is simple in the production and cost effective and which converts the force of waves into electric energy with a low operating weight while avoiding the above-mentioned deficiencies.

This object is solved, according to the invention, by the features of claim 1.

The sub-claims are advantages further embodiments of the invention.

The invention is based on the finding to convert the force of the waves resulting from the movement of the waves into rotational energy and, finally, into electrical energy.

According to the invention, the wave power generator unit comprises a first floating component and a second stationary component, at least one translational element and at least one rotational element. The stationary component and the floating component are moveable relative to each other by means of the movement of the waves. Therefore, the stationary component has not moved during operation, wherein a demounting or displacement is still possible by means of unusual environmental influences. The translational relative movement of the two components forces a translational movement between the rotational element and the correlated translational element. The floating component, the stationary component, the translational element and the rotational element are in operational relationship with each other. The translational relative movement between the rotational element and the related translational element, therefore, generates a rotation of the rotational element. As is known per se, there are many possibilities how a translational movement can be converted into a rotational movement. For example, this can be affected through worm gears, lift spindles or gyro units or the like.

Furthermore, the rotational element is in operating relationship with at least one associated generator which converts the rotational energy into electrical energy. This can be done by transmitting the rotational movement of the rotational element to the driving shaft of a generator, for example by friction. Furthermore, a direct coupling of the generator rotor to the rotational element can be considered. The rotational energy is converted into electrical energy by means of at least one generator. For example, it can be implemented as it is usual with hybrid vehicles or wind energy wheels. The energy thus obtained, is transmitted through an electrical conductor from the wave power generator unit.

Thereby, electrical energy is generated by using the anyway existing waves in an environmentally friendly and inexhaustible way. By means the conversion of translational into rotational movement, inertia storages are used in an optimal way. Furthermore, a device having a substantially low operating weight can be realized by such a solution.

According to a first embodiment, a gear unit is provided between the translational element and the rotational element. It is advantages therein that a gear unit can be adapted to the requirements of transmission.

In a particularly advantages embodiment, the rotational movement is transmitted through a free wheeling gear unit to the rotational element. The free wheeling gear unit allows the transmission of moment only in one rotational direction. The rotational element can, therefore, always be driven only in one rotational direction. It is not braked down by a slowly rotating nor by a oppositely rotating driving side. This has the advantage that the rotational element constantly outputs the stored energy.

In a particularly advantages embodiment, at least one translational element is directly or indirectly connected to the stationary component. At least one rotational element is integrated into the floating component in a watertight manner and is rotatably supported there. The translational element is in operational relationship with the floating component as well as with the rotational element. This ensures a relative translational movement between the floating and the stationary component along the translational element and, by means of the integration of the rotational element into the floating component, also a translational movement between the rotational and the translational element. It is obvious in this case that at least one generator which is also operationally associated with the rotational element, is integrated into the floating component. This has the advantage that the installation of the power station in the sea is considerable simplified.

As an alternative thereto, the rotational element is integrated into the stationary element in a watertight manner and the translational element is connected to the floating component. The floating component moves, because of the swell, relative translationally with respect to the stationary component, wherein the translational element is thereby moved relative to the rotational element. The rotational element is caused to rotate by the translational element due to this relative movement. The generator is located, in this embodiment, in the stationary component. This embodiment has the advantage that the weight to be supported by the floating component is minimized.

It is, furthermore, advantageous that the stationary component and/or the floating component are formed at least in two parts. This substantially facilitates the installation as well as the maintenance work at the respective components. Furthermore, it makes sense to provide an entrance lock for large wave power generator units. The entrance lock is, therein, adapted to be air tightly locked and offers access to the inside of the wave power generator unit in order to carry out maintenance work. The entrance lock, is, therein, configured such that it allows access for the maintenance personnel as well as for the required material. Furthermore, the installation is pronouncedly simplified thereby.

In further advantage embodiment, at least one damping element is provided between the floating component and the stationary component. This has the task to avoid a hard bumping of parts on each other, i.e. of the floating component and/or parts connected thereto with parts of the stationary component and/or with parts connected thereto, with high swell. This puts up significantly the lifetime of the power generator unit and reduces the load on the material. Dampening elements may, for example, be located between the stationary component and the translational element and/or between the floating component and the translational element.

Furthermore, at least one resetting element is provided which is in operational relationship with the floating component as well as with the stationary component. This element has the task to store energy while being deflected by the crest of a wave and to output it on occasion of the next wave valley such that the floating component may slide back into its original position along the water surface. This has the advantage that the maximum wave upstroke is used in an optimal way. Resetting elements can also be located between the translational element and the floating component and between the translational and the stationary component as well.

Furthermore, the dampening element and the resetting element may form a constructional unit. This influences the overall construction in the sense of weight reduction as well as cost reduction.

According to a further advantage embodiment, the translational movement is converted by means of a drill rod and a flywheel into a rotational movement. The drill rod comprises, in a portion thereof, a left hand and/or right hand worm gear and is supported by a receipt in the center of the flywheel. By means of a relative movement of the flywheel along the drill rod, through the thread of the flywheel, it is brought into rotation. Therein, the drill rod corresponds to the translational element and the flywheel to the rotational element. Therein, the flywheel is arranged such that it comprises a comparatively large portion of its weight in the circumferential area. This makes particular sense, first of all, for storing of mechanical energy. In case higher forces are encountered, it can be considered to form the drill rod as a gear rod because it can withstand higher forces.

Advantageously, the free wheel is connected to the drill rod through a free wheeling gear unit which can be realized through a claw clutch. Therein, the claw which is put into rotation by the drill rod, engages a catching cam which is chamfered opposite to the rotational direction. The catching cam is connected to the flywheel. By the chamfer of the catching cam a free wheeling gear unit is formed. This embodiment is particularly cost effective. As an alternative thereto, the free wheeling gear unit can be configured as it is usual with bicycles.

In particular, the generator may comprise a drive shaft and a gear wheel fixed thereto. In order to transmit the movement of the free wheel, the gear wheel engages gears provided at the free wheel. Therein, the driving shaft of the generator may be located perpendicularly or in parallel to the axis of the free wheel. This has the advantage that several redundant generators put up the security in case of failure.

In a further advantage embodiment, the rotor of the generator is connected to the flywheel which is moving relative to the stator of the generator. This has the advantage that the electrical energy is generated without additional friction losses.

In particular, a step-up gear unit is provided between the translational element and the generator. It can be located between the translational element and the rotational element or between the rotational element and the generator as well. A gear unit which is automatically switchable depending on the swell, is particularly advantages. This considerably improves the efficiency of the wave power generator unit.

Preferably, the free wheel is connected to the floating component, the drill rod is connected to the stationary component. Thereby, the wave power generator unit generates energy out of the relative movement of the flywheel to the stationary drill rod. As an alternative thereto, the flywheel and the stationary component and the drill rod can be connected to the floating component. In both modifications, always the free wheel and the drill rod are in operational connection.

In a further advantages embodiment, the floating component of the wave power generator unit is formed as a floating buoy. This has the advantage of a well-proven shape as well as of a low price production. Furthermore, it is advantageous to form the stationary component as an anchor plate. This guarantees a simple transportation and a simple fixing of the wave power generator unit on the sea bottom. Furthermore, it is advantageous to provide a spring, in particular a tension spring, between the anchor plate and the floating buoy. Therein, the spring is a resetting and/or dampening element.

In particular in coast areas, an embodiment in which a so-called coastal power station housing is provided which comprises the stationary component of a wave power generator unit is particularly suitable. Therefore, it is connected to the steep coastal bottom. It may comprise a hollow cylindrical basic shape, and it can be formed out of metal or concrete. A floating component which can be formed as a cylindrical barrel and which is connected to the translational element, is moving in the interior of the cylinder through the penetrating waves relative to the coastal power station housing comprising a hollow cylindrical basic shape. A rotational element is integrated into the coastal power station housing which element is in operational connection with the translational element. By means of the relative movement of the translational element, the rotational element is put into rotation. A generator is sensibly also integrated into the stationary component and converts the rotational energy into electrical energy. This coastal arrangement has the advantage that no submarine level cable is necessary for leading off the electrical energy.

Further advantages, features and potential applications of the present invention may be gathered from the description which follows, in conjunction with the embodiments illustrated in the drawings.

Throughout the description, the claims, the abstract and the drawings, those terms and associated reference signs will be used as are notable from the enclosed list of reference signs. In the drawings

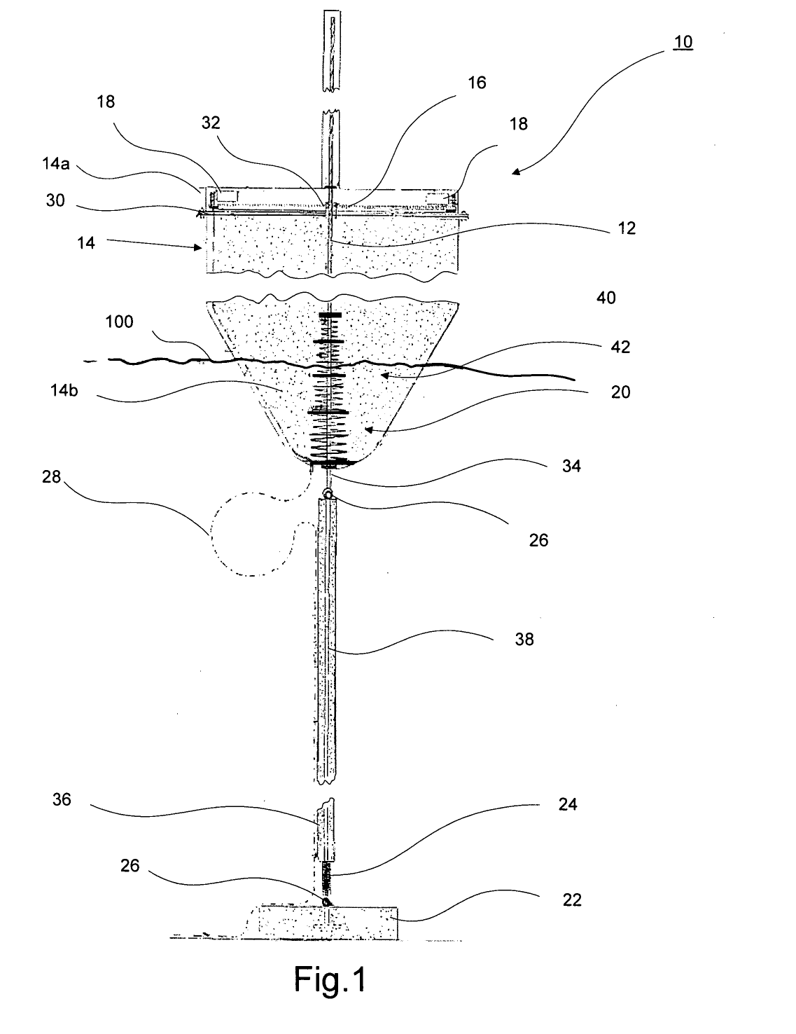

FIG. 1 is a schematic presentation of a wave power generator unit in a wave valley;

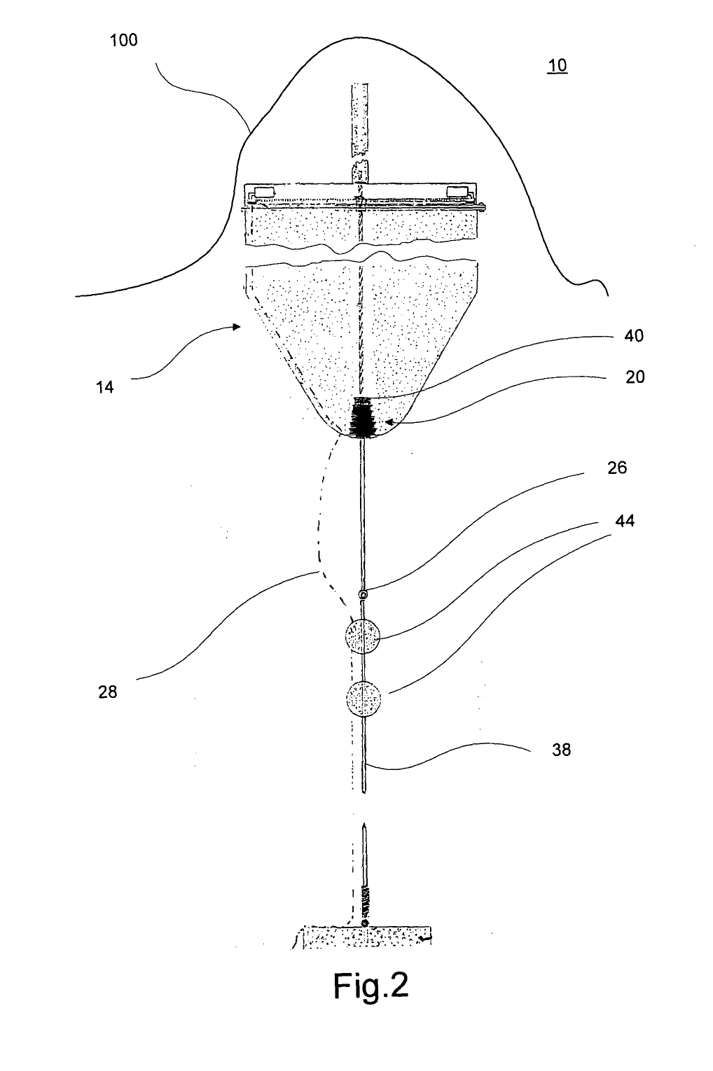

FIG. 2 is a schematic presentation of the wave power generator unit on a wave crest;

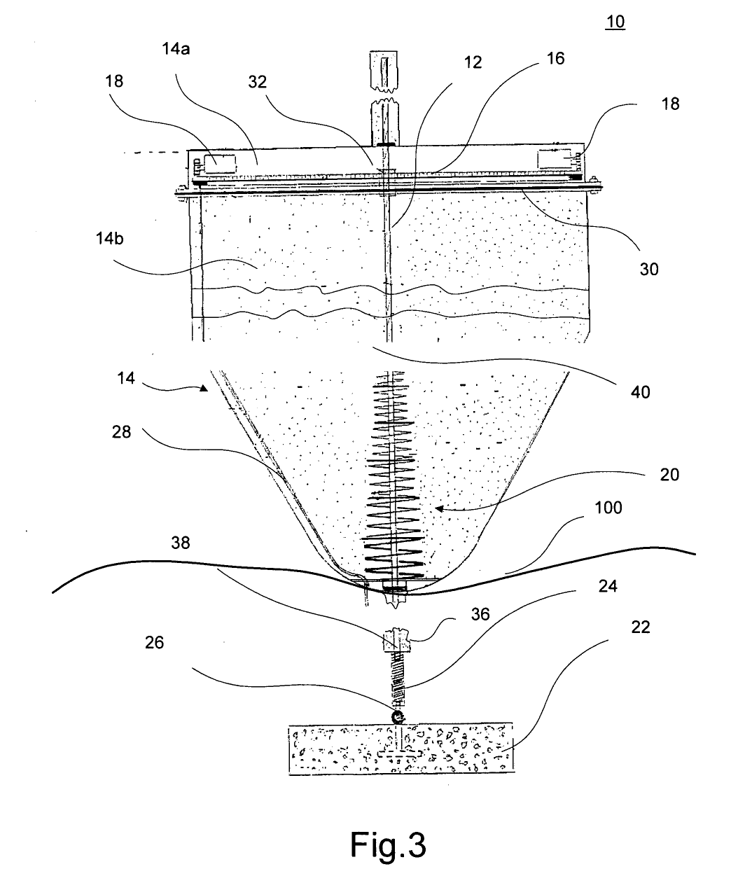

FIG. 3 is a schematic section of a wave power generator unit without anchoring rod in a wave valley;

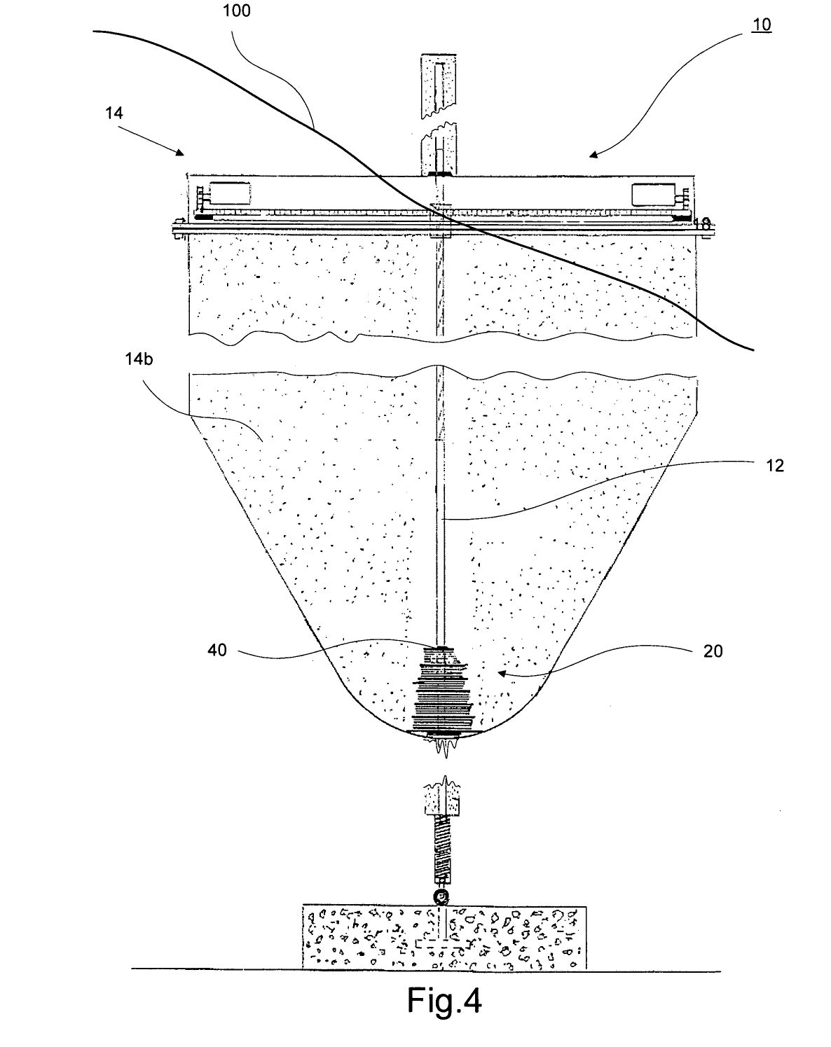

FIG. 4 is a schematic presentation of a wave power generator unit without anchoring rod in the maximal elevated stage;

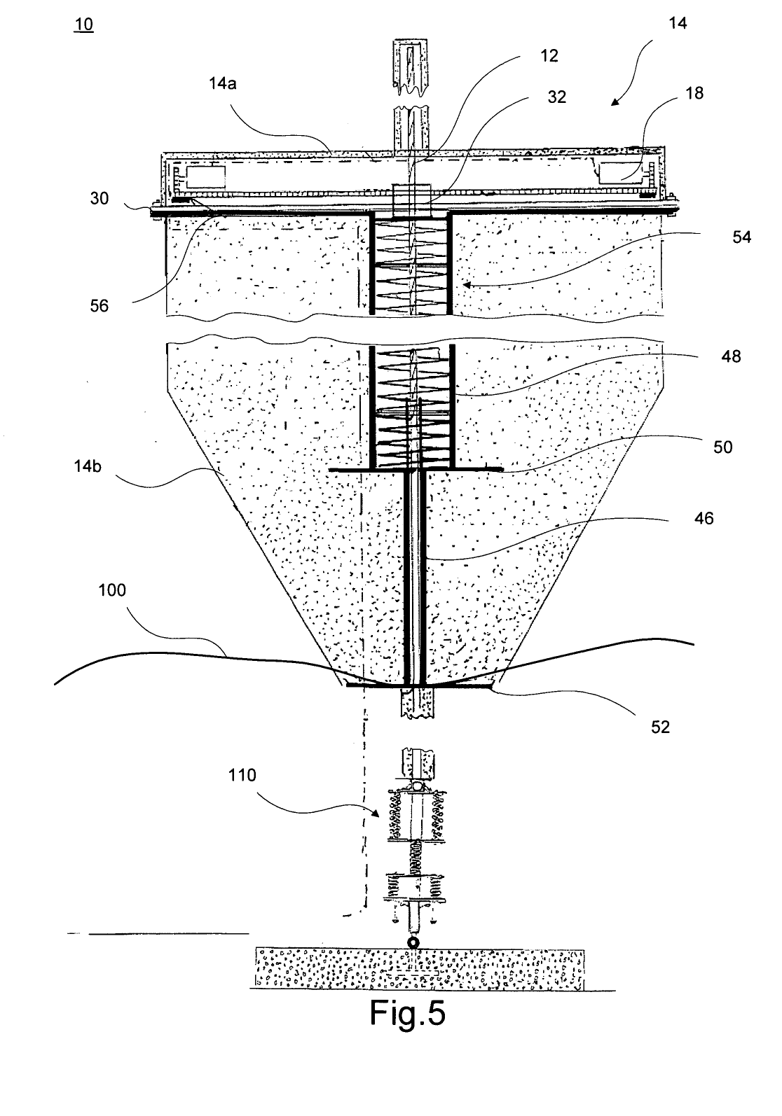

FIG. 5 is a schematic section of a wave power generator unit with an interior housing in a not elevated stage;

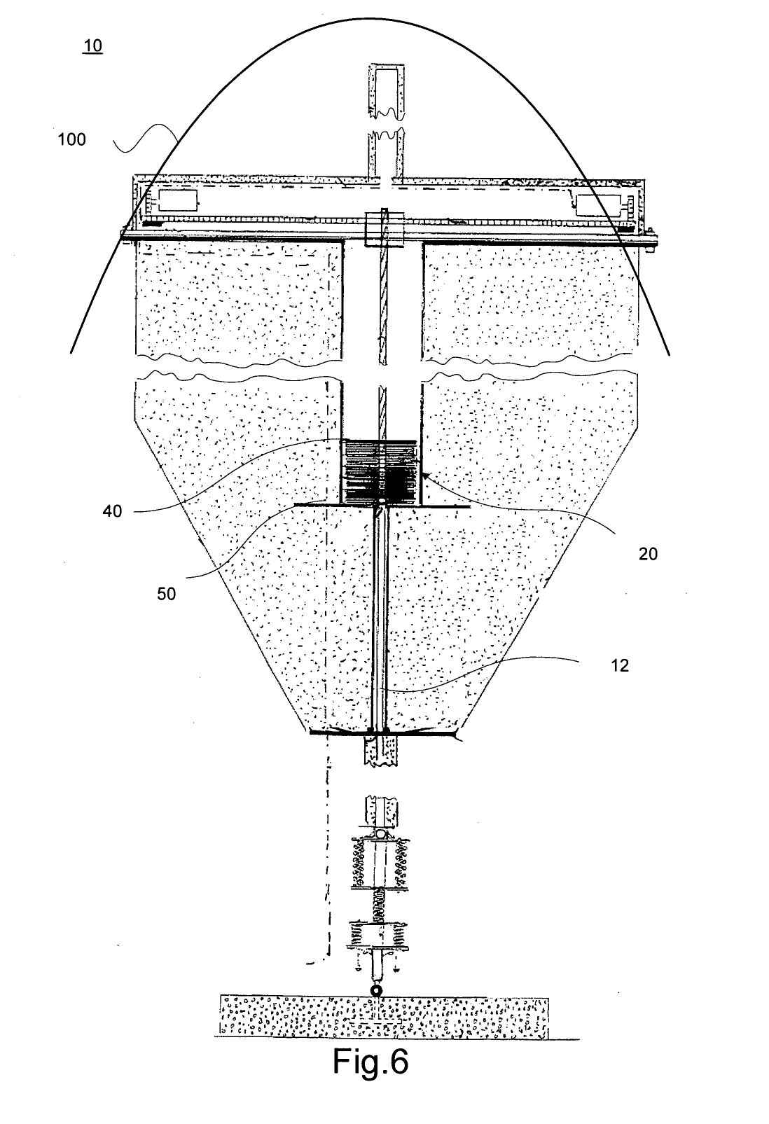

FIG. 6 is a schematic section of a floating buoy wave power generator unit with an interior housing in the maximal elevated stage;

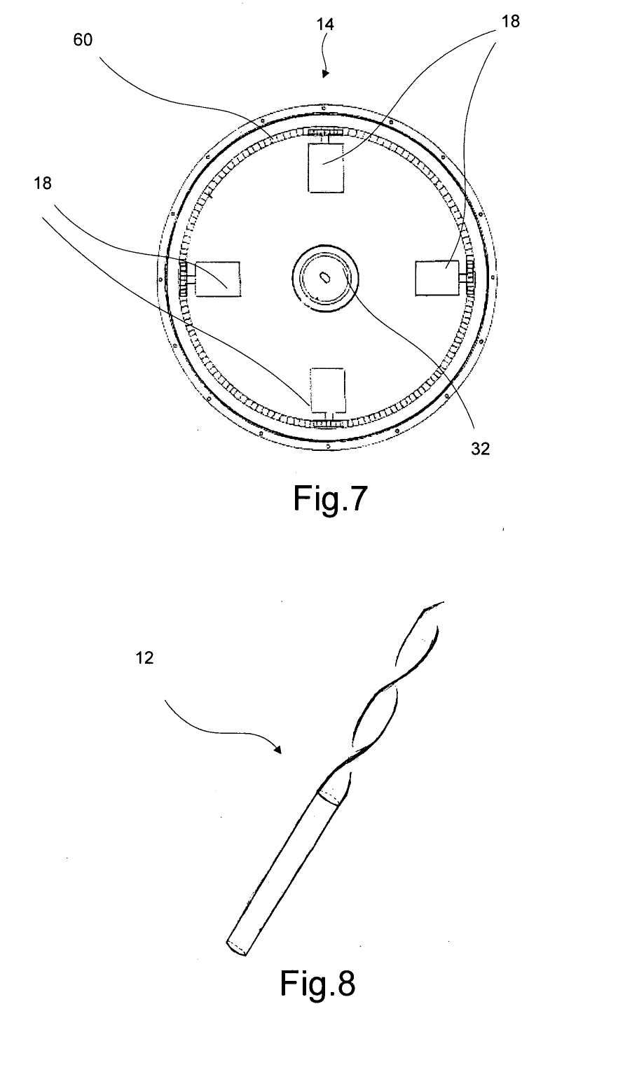

FIG. 7 is a schematic top view on a flywheel of a floating buoy;

FIG. 8 is a schematic presentation of a section of the drill rod in a transition area;

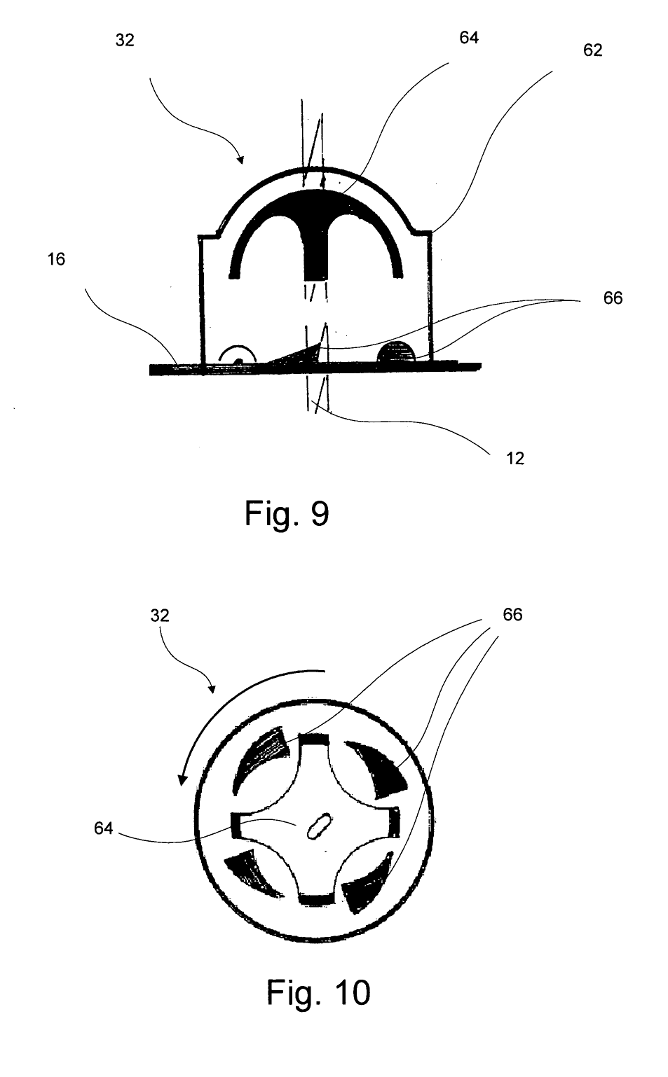

FIG. 9 is a schematic section of the free wheeling unit;

FIG. 10 is a schematic top view of the free wheeling unit;

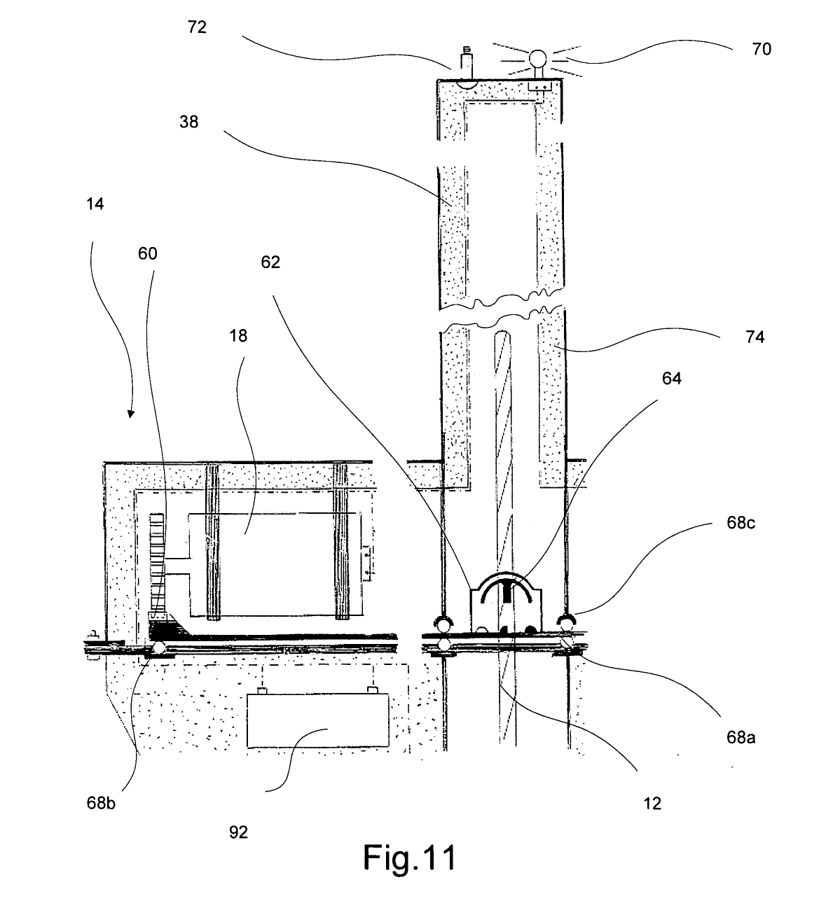

FIG. 11 is a schematic partial section of the floating buoy cover;

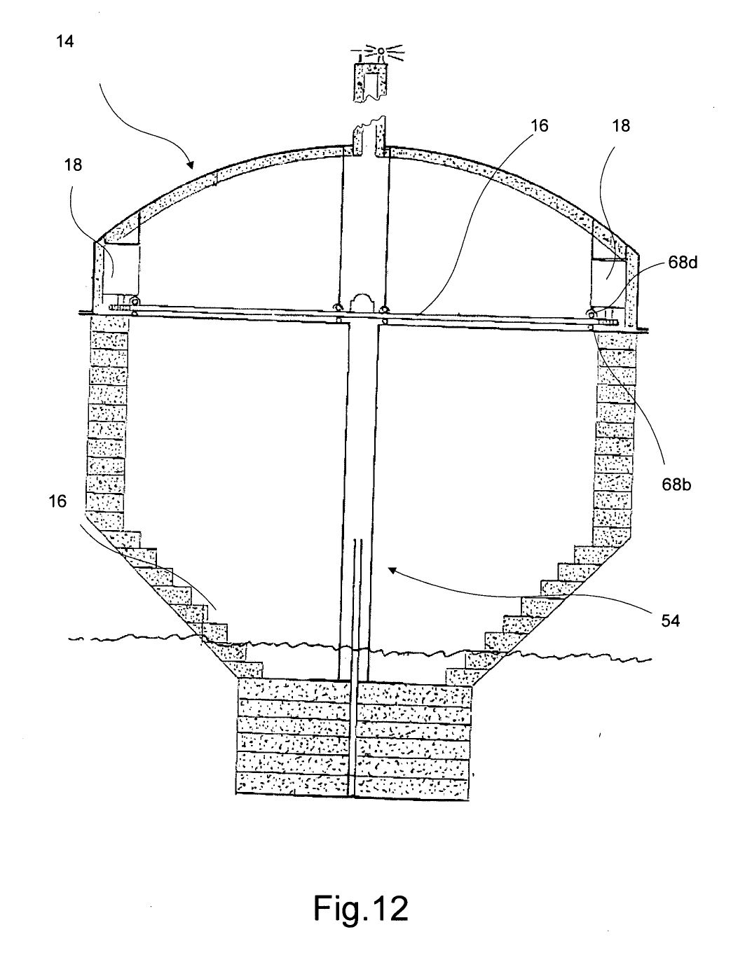

FIG. 12 is a schematic section of a floating buoy in mushroom shaped implementation;

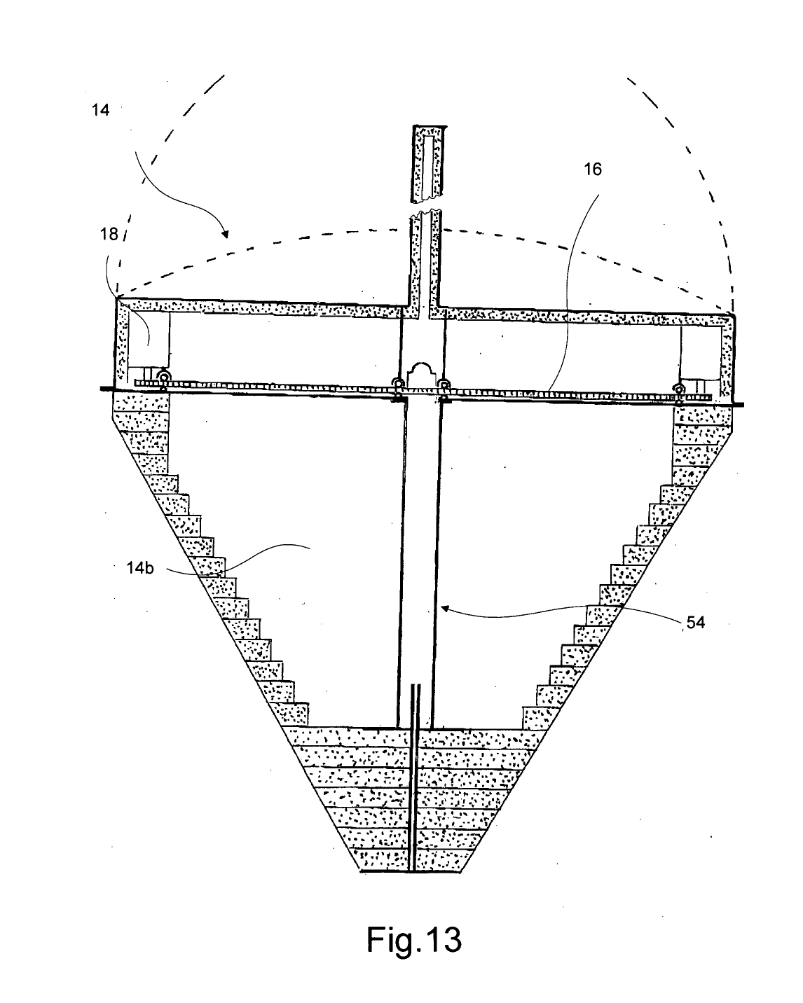

FIG. 13 is a schematic section of a floating buoy in a cone-shaped implementation;

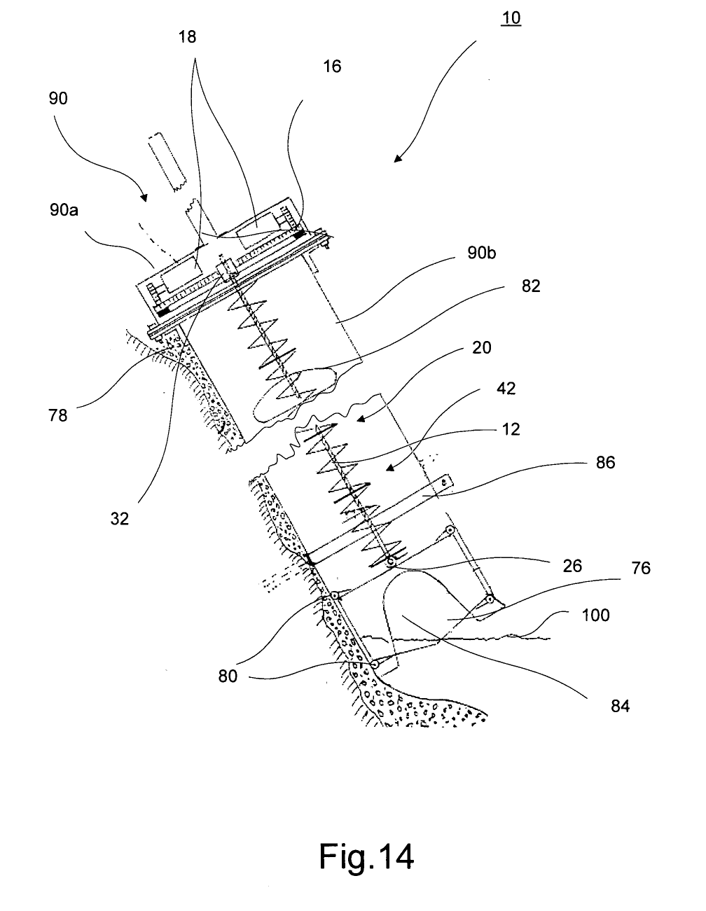

FIG. 14 is a section of a wave power generator unit for rocky coasts in a non-elevated stage;

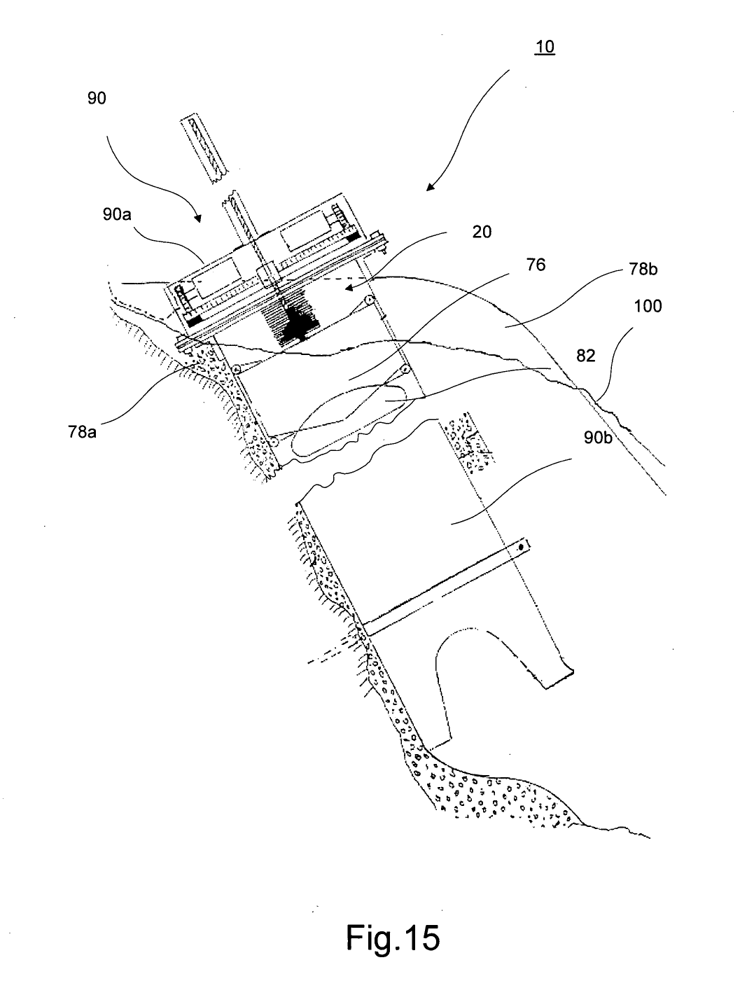

FIG. 15 is a section of a wave power generator unit for rocky coasts in an elevated stage;

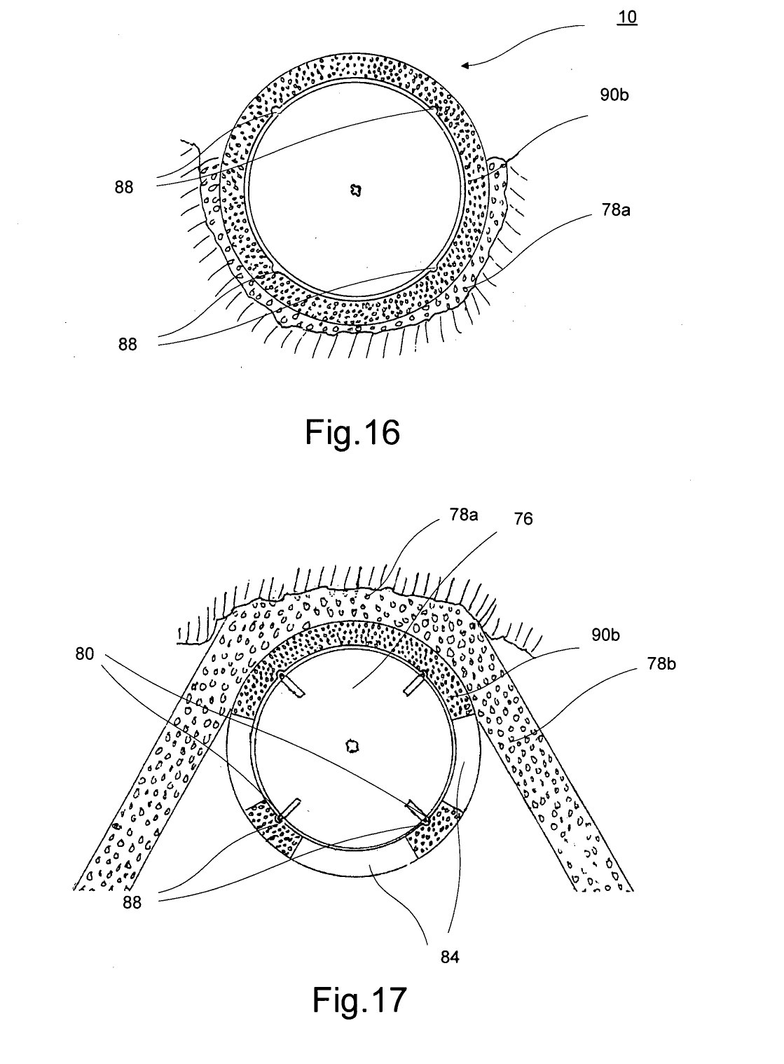

FIG. 16 is a top view on the wave power generator unit for rocky coasts;

FIG. 17 is a section of the wave power generator unit for rocky coasts with a V-shaped wall;

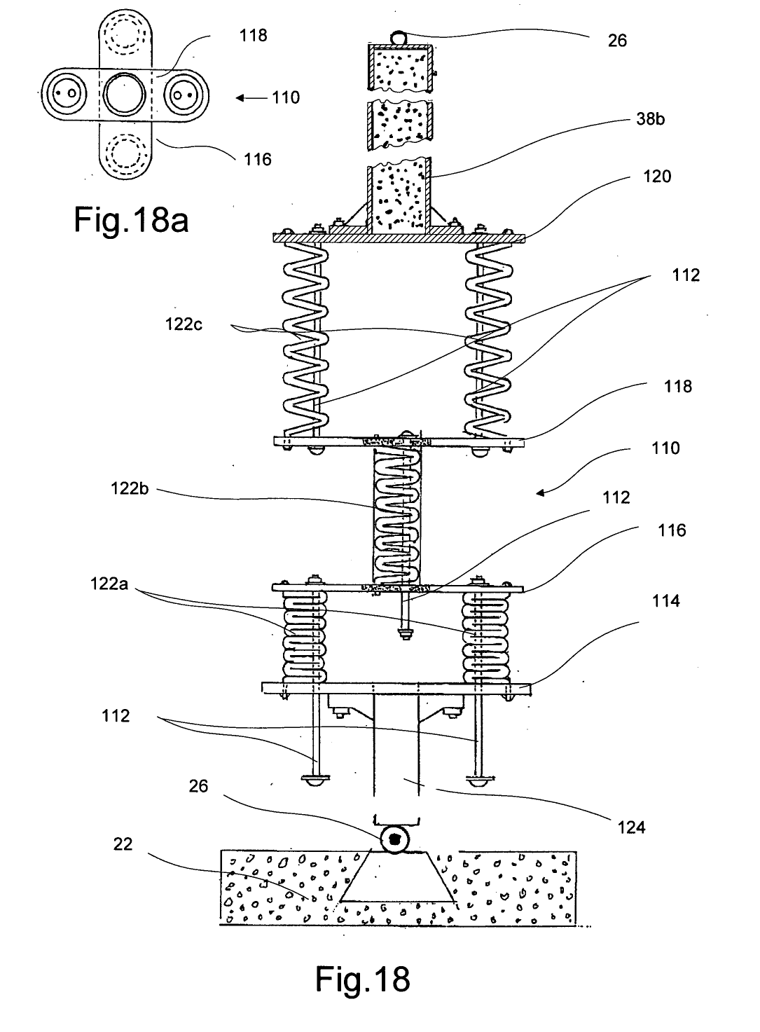

FIG. 18 is a side elevation of the spring block;

FIG. 18a is a top view on the spring block;

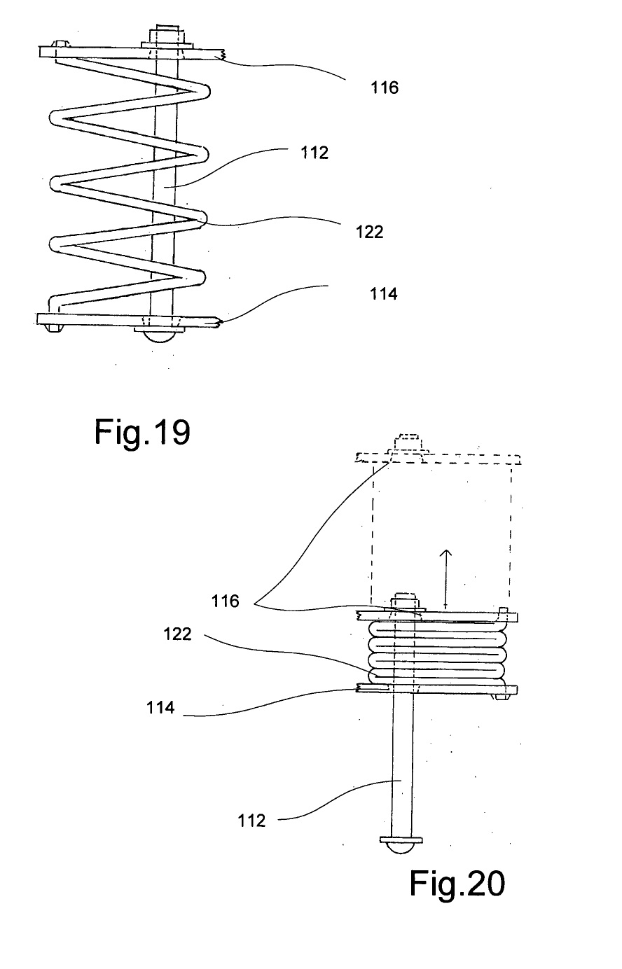

FIG. 19 is a detailed portion of the spring block with extended spring;

FIG. 20 is a top view on the spring block with compressed spring;

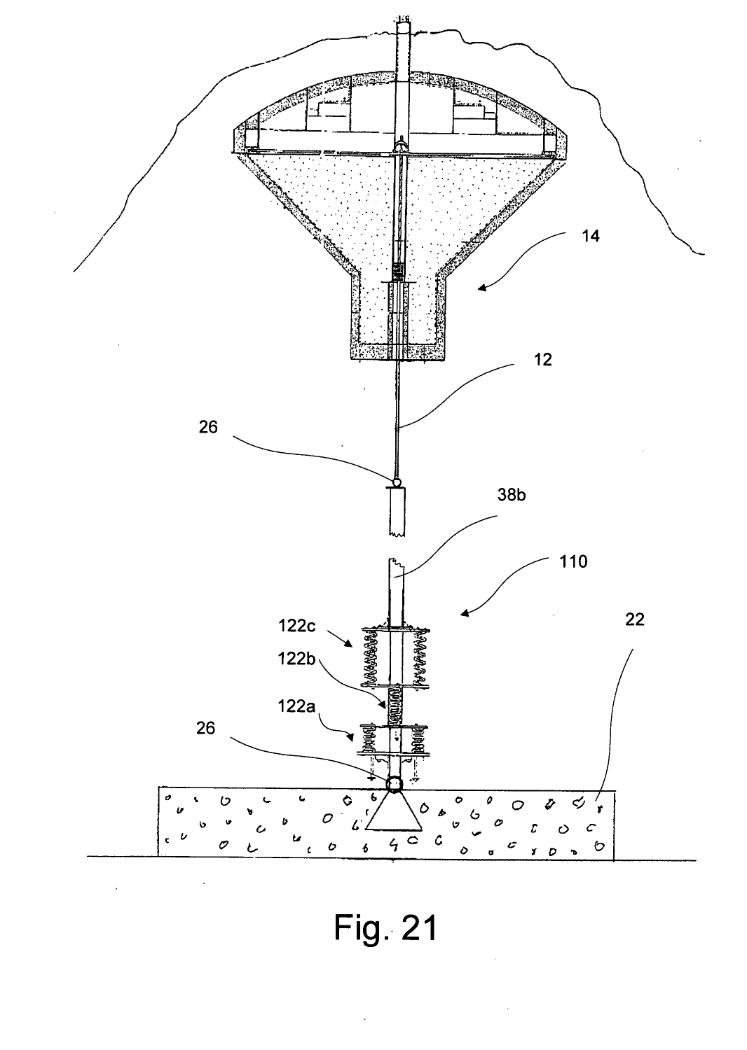

FIG. 21 is a presentation of a wave power generator unit with integrated spring block, and

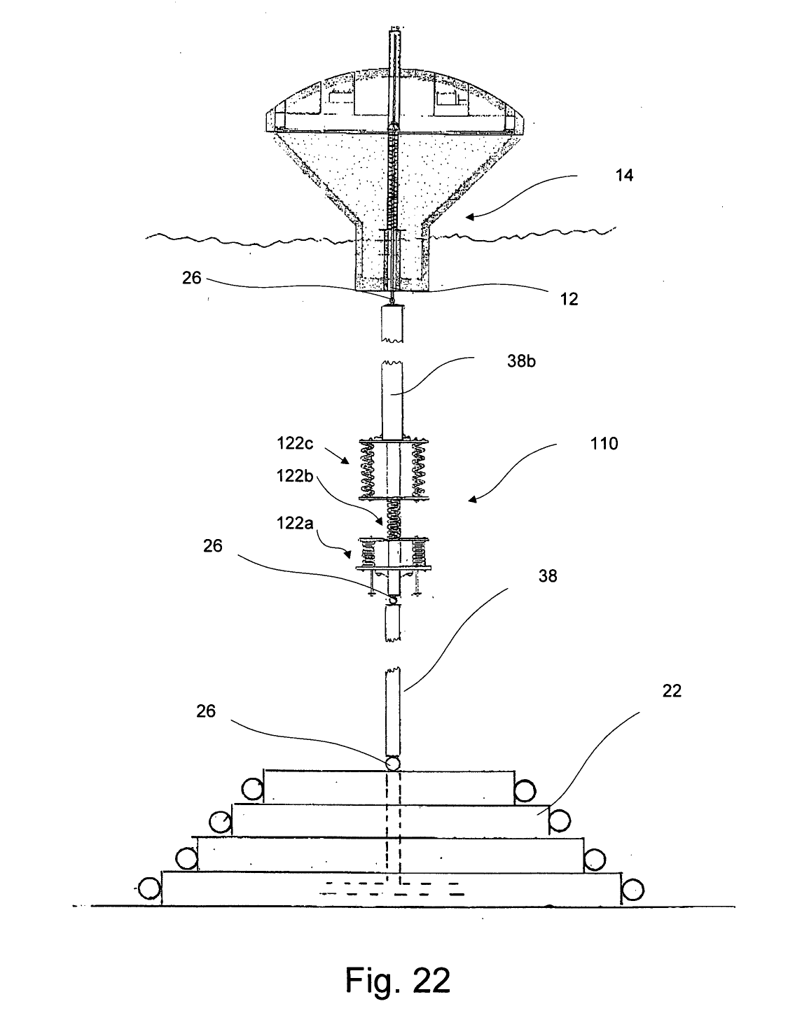

FIG. 22 is a presentation of a wave power generator unit with integrated spring block located nearer to the water surface.

FIG. 1 shows a schematic presentation of a wave power generator unit 10 at low swell. The wave power generator unit 10 comprises, as a floating component, a floating buoy 14 having a floating buoy cover 14a and a floating buoy body 14b.

The floating buoy cover 14a and the floating buoy body 14b are connected by screws. In between the floating buoy body 14b and the floating buoy cover 14a, an air tight, salt water resistant sealing band 30 is provided. In the floating buoy cover 14a, generators 18 or dynamos, respectively are fixed the driving wheels of which engage into gears at the edge area of the flywheel 16. The flywheel 16 represents the rotational element in this embodiment. The fixing of the flywheel 16 on the floating buoy 14 can be taken in detail from FIG. 10. The flywheel 16 is put into rotation based on its movement relative along the drill rod 12 by means of a free wheeling gear unit 32. The drill rod 12 comprises a worm thread in its upper region across which the flywheel 16 is moved.

The drill rod 12 is connected to the anchoring rod 38 through a fixing ring 26, wherein the anchoring rod 38 comprises a floatable envelop 36. Instead of the floatable envelop 36, an anchor tube with a floatable filling, as it can be recognized in FIGS. 21 and 22, can be selected as a replacement. The anchoring rod 38 is connected to the anchor plate 22 through a volute spring 24 and by means of a further fixing ring 26. Instead of the volute spring 24 it can also be considered to integrate a homorganic joint. The anchor plate 22 thus comprises the stationary component of the wave power generator unit. It has to be considered as stationary since it is not moving within the system of the wave power generator unit in operation and since it enables the floating buoy 14 being in operative connection with the anchor plate 22, remove relative to it caused by the swell. A possible displacement by demounting or unusual environmental influences does not impair its stationary position. The anchor plate 22 is connected to the translational element, the drill rod 12, through the anchoring rod 38. As can be taken from FIG. 1 further on, a tension plate 40 is fixed to the drill rod 12. In between the tension plate 40 and the lower part of the floating buoy body 14b, a spring column 20 is located which is, thereby, in operative relationship with the floating as well as with the stationary component through the anchoring rod 38. The spring column 20 comprises, therein, a plurality of springs having different spring parameters. The springs are each connected with each other by further, intermediate tension plates 42. The diameter of the central tension plate 42 is somewhat larger than the largest diameter of the two adjacent springs. In the middle, the tension plate 42 comprises a cut-out of oval shape through which the drill rod 12 is adapted to slide.

The anchor plate 22 is, advantageously, formed out of armoured concrete since it can be cost effectively produced. The dimensions and, thereby, also the weight of the anchor plate 22 is dimensioned such that the wave power generator unit 10 is immovably held in its position. The mass corresponds to about three times the lifting power of the connected floatable buoy 14. The fixing rings 26 are formed out of salt water resistant, high quality steel, wherein the material thickness is dimensioned such that they are not to be exchanged over tens of years.

The volute spring 24 fixed to the fixing ring 26 of the anchor plate 22, connects the anchor plate 22 and the anchoring rod 38. The volute spring 24 fulfills a similar function as the homorganic joint since it can only be extended to a minimal amount. It allows the adjacent anchoring rod 38 to pivot in all directions, where the spring force acts in the sense to vertically aligning the anchoring rod 38. The effect of this force is, therefore, an advantage over the pure joint. The volute spring 24 is formed out of salt water resistant chromium steel. The anchoring rod 38 adjacent to the volute spring 24 is also made out of salt water resistant steel or plastic material.

Since, because of the sea currents, the anchoring rod 38 is not standing exactly perpendicular in the water, the weight of the anchoring rod 38 has an influence on the floatable buoy 14 fixed thereto. It is drawn downwards by the load. In order to avoid this, the anchoring rod 38 is covered by a floatable envelop 36 which carries the self-weight of the anchoring rod 38 and generates, on top of that, an additional buoyancy for the floatable buoy 14. The envelop is formed out of Styrodur since Styrodur is resistant to salt water to a large extend and since only a minimal additional processing, for example against ultraviolet radiation, is required in order to bring about a complete salt water resistance.

The anchoring rod 38 is connected to the drill rod 12 which comprises an oval cross section, by a further fixing ring 26. The detailed arrangement of the drill rod 12 is explained in more detail in FIG. 8.

The drill rod 12 extends through a sealing hub 34 into the interior of the floatable buoy 14b. The floatable buoy 14 is, thereby, able to translationally move on the drill rod 12. A rotation of the floatable buoy body 14b is impossible because of the oval shape of the drill rod 12 as well as the oval seat of the sealing hub 34. The sealing hub 34 prevents, at this location, the intrusion of water into the floatable buoy 14 to a large extend. For the case that water is intruding into the floatable buoy 14 in some way, the interior space of the floatable buoy 14 is filled with Styropor. This avoids, in any case, sinking of the floatable buoy 14.

The spring column 20 is positioned between the upper-most tension plate 14 and the bottom side of the floatable buoy body 14b. The pressure springs are dimensioned such that the floatable buoy 14 is moved back into the wave valley and jumping of the floatable buoy 14 from wave crest to wave crest is prevented. The assembly of the individual springs is selected such that the movement of the floatable buoy 14 back into the wave valley is optimized for each swell. Furthermore, the spring column 20 is selected such that the upward swimming which is unhindered to a large extend, of the floatable buoy 14 is not influenced. Furthermore, the spring column 20 fulfils the task of dampening. By means of the springs, the bumping of the upper-most tension plate 40 and the lower portion of the floatable buoy body 14b is dampened at high lifting of speed of the floatable buoy 14. This significantly relieves the material. The length of the cable is dimensioned such that it cannot be torn off also in case the floatable buoy 14 is lifted to a maximum.

In case the floatable buoy 14 is lifted by a wave 100, also the flywheel 16 connected to the floatable buoy 14, is moved upwards along the drill rod 12. Thereby, the flywheel 16 is caused to move. Electrical energy is generated from this movement by the generators 20, the driving wheels of which are engaging into gears on the flywheel 16. The generated electrical energy is transferred to land by means of a submarine cable 28.

FIG. 2 shows a schematic section of a wave power generator unit 10 similar to FIG. 1. In contrast to FIG. 1, the wave power generator unit 10 is shown at a high wave. Furthermore, the anchoring rod 38 is not enveloped but is carried by adjustment floats 44. As an alternative, both modifications may be combined. The adjustment float 44 is dimensioned such that the weight of the anchoring rod 38 is carried and, furthermore, additional buoyancy for the floatable buoy 14 is generated. Furthermore, it is to be seen that, in case of a high wave, the spring column 20 is completely compressed between the upper-most tension plate 40 and the bottom portion of the floatable buoy body 14b. A correspondingly large wave can, therein, also completely swash over the floatable buoy 14. Just in this case, it is the task of the spring column 20 to bring the floatable buoy 14 again into its starting position, particularly important.

Furthermore, one can see that the drill rod 12 is extended to a maximum and all springs are compressed. The upper fixing ring 26 has to be particularly considered in this drawing. It has the advantage that the floatable buoy 14 must not be demounted from the sea ground with maintenance works but can be decoupled at the transition from anchoring rod 38 to the drill rod 12. This facilitates the maintenance work.

FIG. 3 shows a schematic section of a floatable buoy 14 in a wave valley or in a low wave 100, respectively. In this presentation, the drill rod 12 is directly connected to the anchor plate 22. This puts up the stability since no additional, disconnectable transition is provided. This modification is particularly adapted for shallow coastal areas. The spring column 20 which is positioned between the upper tension plate 40 and the lower portion of the floatable buoy body 14b is relieved from tension in this stage of the floatable buoy 14.

In this embodiment, also an envelop 36 of the drill rod 12 is provided. This is also formed out of Styrodur. The drill rod 12 is connected also in this embodiment through a volute spring 24 and a fixing ring 26 to the anchor plate 22. The anchor plate 22, the fixing ring 26 and the volute spring 24 are formed as described in FIG. 1.

The sealing band 30 which is positioned between the floatable buoy upper portion 14a and the floatable buoy body 14b is to be seen here particularly well. The integration of the generators 18, the flywheel 16 and the free wheeling gear unit 32 is carried out as described with FIG. 1.

In FIG. 4, the wave power generator unit of FIG. 3 is shown in a lifted status. The compression of the spring column 20 between the upper tension plate 40 and the floatable buoy body 14b is again to be seen here comparable to FIG. 2. The sectioning of the oval drill rod 12 into a smooth and a second part provided with a worm tread can be seen here particularly well.

FIG. 5 shows a schematic section of a further embodiment. An embodiment is shown here which comprises an interior housing 54. It comprises a bottom plate 52, a tension rod housing 46, an adjustment plate 50, a spring housing 48 as well as a body connection 56. All parts of the interior housing 54 are connected to each other in a fluid tight manner.

Therein, the tension rod housing 46 is arranged adjacent to the bottom plate 52 which comprises a cut-out for the drill rod 12 gliding there through. The adjustment plate 50 forms the final portion of the tension-rod housing 46. An oval cut-out in the adjustment plate 50 allows the drill rod 12 to slide there through without rotation. The transition to the spring housing 48 is protected against intrusion of water. By means of this embodiment, the drill rod 12 is not braked down upon gliding upwards and downwards. The spring housing 48 is also connected to the adjustment plate 50 in water and air tight manner. This has the advantage that oil may be filled into the spring housing 48 whereby the drill rod 12 is lubricated. Since oil has a lower density than water, it cannot get into the sea water. Therefore, a contamination of the environment is excluded. At the upper end of the spring housing 48, the body connection 56 is subsequently formed in a water and air tight manner. It provides for a possibility for the connection with the floatable buoy cover 14a in the edge area. A seal 30 between the body connection 56 and the floatable buoy cover 14a provides air and water tightness. As also mentioned in the proceeding figures, the flywheel 16, the free wheeling gear unit 32 and the generators 18 are located in the area of the floatable buoy cover 14a.

In this embodiment, also a spring column 20 is provided which is located between the upper-most tension plate 40 and an adjustment plate 50.

Since in this embodiment the interior housing 54 forms the frame work of the floatable buoy 14, the rest portion of the floatable buoy body 14b can be designed comparatively freely. The rest of the floatable buoy body 14b is completely formed out of Styrodur in this embodiment. The Styrodur is provided with an ultraviolet resistant, salt water resistant painting in order to comprise the required durability. This allows a very cost effective production.

A spring block 110 is provided between the anchor plate 22 and the drill rod 12 for a better dampening of high wave forces. The spring block comprises, in this presentation, as described in more detail in FIG. 19, three pairs of springs with differing tension force. Furthermore, a limitation for the extension is provided for enlarging the life time of the springs of the spring block. The spring block is mounted against rotation, and it is coupled to the anchor plate 22 as well as to the drill rod 12 through fixing rings 26. Thereby, a plurality of springs are in operational relation ship between the floating component and the translational element as well as a plurality of springs are between the translational element and the stationary component.

FIG. 6 shows a wave power generator unit in the embodiment of FIG. 5, however, with high swell 100 in the state of being lifted to a maximum. Like in the FIGS. 2 and 4, the compression of the spring column 20 as well as the completely extended drill rod 12 are to be seen here. As in FIG. 5, the spring block 110 is provided between the anchor plate 22 and the drill rod 12 also in this FIG.

FIG. 7 shows a schematic top view of the flywheel 16 of a floatable buoy 14. The flywheel gear teeth 60 into which the drive wheels of the generator 18 are engaging, is to be seen particularly well in this presentation. In this case, four generators are shown. The integration of plural generators 18 means, on the one hand, a higher efficiency and, on the other hand, a better security against failure because of redundancy.

In the centre of the flywheel, one can see the free wheeling gear unit 32 in top view in the middle of which there is a cut-out as a passage for the drill rod 12.

FIG. 8 shows as a partial view the transition area of the drill rod 12. The lower part of the drill rod 12 comprises an oval sectional shape and a smooth outer surface. The oval basic shape with the smooth surface allows a gliding of the drill rod 12 without rotation at a correspondingly oval receipt. The upper portion comprises a worm thread which is formed for driving the flywheel 16.

FIG. 9 shows the implementation of the free wheeling gear unit 32 by means of a bell shaped claw 64 in cross section. The fee wheeling gear unit 32 is formed similar to a toy gyro. Therein, the free wheeling gear unit 32 comprises a gear cover 62 which is fixedly connected to the flywheel 16.

The drill rod 12 extends through the flywheel 16 as well as the gear cover 62. Furthermore, the drill rod 12 extends through the bell shaped claw 64 which is supported be moved vertically as well as rotationally. In this embodiment, the flywheel 16 comprises catching cams 66. The catching cams 66 are, as can be seen this representation, formed in the shape of a half curved cone to a largest extend. This is a difference to the arrangement of the free wheeling gear unit 32 in a toy gyro. The catching cams 66 are formed there as quarter spheres. Those are, however, not adapted for such a high long term loading in a wave power generator unit 10.

One can see in this representation particularly well that, by a movement between the flywheel 16 and the drill rod 12 during which the drill rod 12 is moving downwards, the torque is transmitted through the catching cams 66 to the flywheel 16. However, if an upward movement is effected, the bell shaped claw 64 is moved into the direction of the gear cover 62 and rotates there relatively freely.

In FIG. 10, one sees very well the arrangement of the curved, sphere shaped catching cams 66 on the flywheel 16 in top view. In the middle, the bell shaped claw 64 is shown. Furthermore, the direction of rotation of the driven flywheel 16 is indicated. By means of this free wheeling gear unit 32, it is possible that the flywheel 16 rotates faster than the bell shaped claw 64. Thereby, the moment of inertia of the flywheel 16 is used in an optimal way.

FIG. 11 shows a detailed section of the floatable buoy 14 according to FIG. 1 or FIG. 2, in particular of the floatable buoy cover 14a. The bearing of the flywheel 16 can be seen particularly well. On the side of the floatable buoy body 14b, the flywheel 16 is supported on two ball bearings 68a, 68b which are concentric to the centre of the flywheel 16. The radially outer ball bearing 68b supports the edge of the flywheel 16 and provides for a defined distance between the gear teeth of the flywheel 16 and the drive wheels of the generator 18. A ball bearing 68c which is connected to the floatable buoy cover 14a, is arranged opposite to the radially inner ball bearing 68a and is fixing the flywheel 16 in a rotatable manner in this way. Also the enforcement in the edge area of the flywheel 16 is clearly to be seen in this figure. This enlarges its inertial mass and provides a uniform current generation.

Furthermore, FIG. 11 shows particularly well the free wheeling gear unit 32 which has already been explained in more detail in the FIGS. 9 and 10, having the catching cams 66 arranged on the flywheel 16. Furthermore, a signal light 70 is provided which is applied to the highest location of the floatable buoy 14. It is provided, therefore, at the portion of the floatable buoy cover 14a which is the covering for the drill rod 12. This part is formed such that the drill rod 12 is taken up with the floatable buoy 14 being supported in a completely relaxed way.

Furthermore, a battery 92 is shown in the floatable buoy body 14b which is connected to the generators 18 and the signal light 70 by cables. On the generator 18, one can see the toothed drive wheel which engages into the gear tooth 60 of the flywheel 16. This ensures a transmission of power which is without loss to a large extend. The fixing of the generator 18 to the floatable buoy cover 14a is also shown. Furthermore, an air valve 72 is provided next to the signal light.

The thermal insulation layer 74 on the floatable buoy cover 14a is also to be seen very well in this presentation. This insulation layer 74 is formed out of Styropor and prevents the development of heat by solar irradiation in the area of the generator.

FIG. 12 shows a floatable buoy 14 in a mushroom shaped arrangement basically according to FIG. 5 and FIG. 6. In contrast to the previous embodiments the drive wheels of the generators 20 due not engage with gear teeth on the upper side of the flywheel 16 but the outer edge of the flywheel is provided with teeth. Gear teeth at the outer edge of the flywheel can be produced more economically than gear teeth on the upper face of the flywheel 16. Accordingly, the generators 18 are vertically arranged in this case.

Furthermore, again a ball bearing 68d is arranged opposite to the radially outer ball bearing 68b. This ensures the vertical stabilization of the flywheel 16 in the outer area. Furthermore, FIG. 12 shows the implementation of the outer wall of the floatable buoy body 14b out of Styrodur. The interior of the floatable buoy body 14b is filled with Styropor. The Styropor filling is not necessary for the functionality of the floatable buoy 14, however, avoids sinking of the floatable buoy 14 in case water intrudes through the outer wall. Furthermore, the floatable buoy 14 shown in FIG. 12, comprises an interior housing 54 as is described in more detail in FIG. 5. This allows a flexible design of the floatable buoy body 14b.

FIG. 13 shows a floatable buoy 14 in a cone-shaped arrangement. As in FIG. 12, the outer wall of the floatable buoy body 14b is also formed out of Styrodur and filled with Styropor. The current generation is effected also by perpendicularly arranged generators 18 which engage gear teeth of the side edge of the flywheel 16. Furthermore, the floatable buoy 14 comprises here also the interior housing 54 described by FIG. 5. Therein, the embodiments shown in FIG. 12 and FIG. 13 are particularly adapted for individual production or for the production of prototypes respectively.

FIG. 14 shows a sectional view of a further embodiment of a wave power generator unit 10 in a shore implementation wherein the coastal power station housing 90 comprises a shore power station housing cover 90a and a shore power station housing body 90b. Therein, the kind of energy retrieval corresponds basically to the one described above. In contrast thereto, the flywheel 16, i.e. the rotational element, and the generators 18 are arranged in the shore power station housing cover 90a. In this embodiment, the coastal power station housing cover 90a and the coastal power station housing body 90b correspond to the stationary component. In this arrangement, the translational element, the drill rod 12, is connected to a cylindrical float 76 representing the floating component, by means of a fixing ring 26. By means of the swell 100, the cylindrical float 76 is moved vertically with the flywheel 16 along the wave power station body 90b and drives, thereby, the flywheel 16 through the free wheeling gear unit 32. The coastal power station housing body 90b is formed as a hollow cylindrical metal body and is screwed to a concrete bed 78a by means of three metal rings 86.

Furthermore, a spring column 20 is shown, where the individual springs are formed as tension springs and are dimensioned such that the weight of the drill rod 12 and the one of the cylindrical float 76 are supported. Therefore, only a small lifting force of the wave is necessary in order to lift the cylindrical float 76. In between the individual springs 42, there are central tension plates 42 which prevent the bulging of the spring. The cylindrical float 76 is moved by its weight as well as by the one of the drill rod 12 back into the wave valley. The electrical energy is retrieved as described in FIG. 1.

Furthermore, the coastal power station housing body 90b comprises three cut-outs 84 at its bottom side. Eight distance rollers 80 are Axed at the cylindrical float 76. Those are in pairs in radial direction with a distance of 90°. For the guidance of the distance rollers 80, guide rails are integrated in the coastal power station housing body 90b which allow an upwards and downwards movement of the cylindrical float 76, but, however, prevents a rotation thereof.

Furthermore, in between the cylindrical float 76 and the hollow cylindrical coastal station housing body 90b, a gap is positioned which is just large enough such that the fine sand which is frequently washed along near the coast, cannot settle down therein. Furthermore, the coastal power station housing body 90b comprises an overflow opening 82 such that, for example with a high wave, the water cannot exert a large pressure onto the cylindrical float 76 which is already completely displaced. Thereby, the wave power generator unit survives also monster waves.

Because of the anchoring of the coastal power station housing 90 in solid landscape, this embodiment is particularly suited for coasts. There, one has furthermore the advantage that the coastal power station housing 90 is easily accessible in case of maintenance works, and that one does not need expensive submarine cables for transferring the current to the main land.

FIG. 15 shows also a section of a wave power generator unit 10 in coastal implementation like FIG. 14, however, with a high wave 100. Therein, one can see particularly well that the overflow opening is cleared at maximum upstroke and that the surplus water can flow off. The spring column 20 is, herein, completely compressed and thereby dampens the impact of the cylindrical float 76 on the upper side of the coastal power station housing body 90b. Additionally, in this presentation, a leg of a v-shaped wall 78b is shown which reaches from the bottom to the coastal power station housing cover 90b. The function of this v-shaped wall is shown in FIG. 17.

FIG. 16 shows a wave power generator unit 10 in a coastal arrangement in top view. Therein, the hollow cylindrical coastal power station housing body 90b is formed out of concrete. This has the advantage that the coastal power station housing body 90b can be constructed worldwide without problems and cost effectively out of concrete rings as used in well or channel buildings. The coastal power station housing body 90b is, as shown, concreted into the concrete bed 78. This has the advantage that the wave power generator unit 10 can withstand a monster wave. One can see the guide grooves 88 which are offset by 90, for the rotation free guidance of the distance rollers 80.

FIG. 17 shows a horizontal section through a wave power generator unit 10 in coastal arrangement. As in FIG. 14, one can also see the guide grooves 88 in the concrete envelop of the wave power station body 90b. Furthermore, one can see a horizontal section through the cylindrical float 76 with the distance rollers 80 offset by 90°. Furthermore, the three cut-outs 84 are shown. One can see in this figure particularly well the concrete bed 78a as well as a more or less v-shaped wall 78b. Skirting the wave power generator unit by the v-shaped wall 78b has the advantage that the waves are cumulatively hitting on the wave power generator unit 10.

FIG. 18 shows a spring block 110 for dampening of very high wave forces. It comprises a spring block bottom 114, a first intermediate plate 116, a second intermediate plate 118 as well as spring block cover plate 120. The spring block 110 comprises a central rod 124, spring pairs 122a, 122b, 122c as well as extension limiting means 112. The spring block bottom 114 is formed as a lengthy plate to the middle of which the central rod 124 is extended. The spring block bottom 114 is immovably connected to the centre rod 124 by means of an angular formation. A first spring pair 122a is connected at both ends of the lengthy plate of the spring block bottom 114 thereto. Above the first spring pair 122a, there is connected a cross-shaped first intermediate plate 116. The spring pair 122a is fixedly connected with the ends of a first cross bracket which is arranged oppositely to the lengthy spring block bottom 114. Furthermore, there are cut-outs at the ends of the first cross bracket as well as at the ends of the spring block bottom 114 within the spring supporting surfaces. These cut-outs allow the integration of extension limiting means 112. The extension limiting means 112 delimit the maximum distance which the spring block bottom 114 and the first intermediate plate 116 can have between each other. This reduces wearing out of the spring pair 122a. A detailed description is effected in the FIGS. 19 and 20. The first intermediate plate 116 comprises a second cross bracket which is arranged perpendicular to the first cross bracket. A second spring pair 122b is again fixed to both ends of the second cross bracket. The second spring pair 122b connects the first intermediate plate 116 with a second intermediate plate 118. The second intermediate plate 118 is also cross-shaped. The second spring pair 122b is connected to the ends of a second intermediate plate 118 positioned with cross brackets above the first intermediate plate 116. The maximum distance of the first intermediate plate 116 and the second intermediate plate 118 is limited by distance limiting means 112 in analogy to the first intermediate plate 116 and the spring block bottom 114.

A third spring pair 122c is again fixed to the ends of the second cross bracket (perpendicular to the first cross bracket) of the second intermediate plate 118. This connects the second intermediate plate 118 with the spring block cover plate 120. Extension limited means 112 are also provided at this transition. The spring block cover plate 120 is also formed as a lengthy plate (corresponding to a cross bracket). Furthermore, a tubular rod 38b is arranged subsequently to the lengthy spring block cover plate 120. The tubular rod 38b is fixedly connected to the spring block cover plate 120 by means of angle brackets. The tubular rod 38b is filled up by floatable material for a better floating performance, and it comprises a fixing ring 26 at the upper end. Furthermore, the spring block 110 comprises a fixing ring 26. It is positioned at the lower end of the centre rod 124 and connects here the spring block 110 with the rod 38b. This allows a modular usage of the spring block 110. The spring pairs 122a, 122b, 122c have differing spring parameters for adjustment to the requirements. Furthermore, it is conceivable that two planes can be connected to each other by more springs than a spring pair 122a, 122b, 122c each. For example, four or eight springs are forming connection between two plates.

FIG. 18a shows the top view of the spring block 110. The cross shaped arrangement of the intermediate plates 116 and 118 is particularly pointed out here.

FIG. 19 shows a detailed view of a spring block. A section of the spring block bottom 114 as well as a first intermediate plate 116 are to be seen. As can be seen in this section, the spring block bottom 114 and the first intermediate plate 116 are connected by a spring 122. The spring is fixed at the first intermediate plate 116 as well as at the spring block bottom 114. In this view, one can see very well the extension limiting means 112. It is formed rod shaped and is guided through holes in the spring block bottom 114 and the first intermediate plate 116. At both ends of the rod shaped tension limiting means 112, there are connectors which are larger in diameter as compared to the holes in the spring block bottom 114 and the first intermediate plate 116. The distance of the connectors defines the maximum distance in which the two connected plates can be positioned with respect to each other. The spring 122 is formed as an extension spring. The extension limiting means 112 prevents a rotation of the first intermediate plate 116 with respect to the spring block bottom 114.

FIG. 20 shows a detailed view of a spring block 110 like FIG. 19, where the spring 122 is compressed in this case. The eccentric arrangement of the extension limiting means 112 within the spring 122 can be seen particularly well at this location.

FIG. 21 shows a floating buoy 14 which is connected through a drill rod 12, to a tubular rod 38b, through a spring block 110 to the anchor plate 22. As described in FIG. 18, the shown spring pairs 122a, 122b, 122c comprise here differing spring parameters to take into consideration the requirements. The respective transitions are provided with fastening rings 26. It is shown particularly well that the tubular rod 38 may have an arbitrary length. In case of larger length, it makes sense to fill up the hollow space of the tubular rod 38b with a floatable foam material. This guarantees, on the one hand, stability and, on the other hand, puts up the self-supporting effect of the system. One can gain another saving in weight for the floatable buoy 14 in general by placing the dampening and back-setting means out of the floatable buoy 14 to near the anchor plate 22. Further downwards this mass is located the lesser it effects the floatable buoy 14.

FIG. 22 shows floatable buoy 14 which is connected through a drill rod 12, through a tubular rod 38b, through a spring block 110, through a anchoring rod 38 to the anchor plate 22. This anchoring rod 38 is formed tube-shaped and is filled with a floatable material. In this embodiment, the spring block 110 is mounted adjacent to the anchoring rod 38 in contrast to FIG. 21. This has the advantage that maintenance works at the spring block 110 can be carried out easily as it is positioned in lesser depth. As described in FIG. 18, the spring pairs 122a, 122b, 122c shown here, comprise differing spring parameters taking into account requirements. Furthermore, it is made clearer in this presentation that the stationary component, in this case the anchor plate 22, is formed out of plural parts. It comprises, in this view four round concrete discs. However, the anchor plate 22 must not necessarily be formed out of four parts but can also comprise an arbitrary number of thinner and, therefore, lighter discs. The modular arrangement of the anchor plate 22 out of plural discs allows a larger mass and, therefore, a correspondingly larger buoyancy of the floatable buoy 14. At the same time, the transportation costs are kept comparatively low since an over-dimensioned anchor plate 22 has not to be transported by a special ship to the desired location, but individual and lighter concrete discs may be transported by a normal ship. For putting down the concrete discs without problems and concentric to each other, it is necessary to build the anchoring rod 38 at first in two parts. The anchoring rod 38 has, therein, to reach up to the water surface. This ensures guidance upon the concrete discs. After completion of the anchor plate 22, the second part of the anchoring rod is again removed and, in its place, a spring block 110 is connected as shown in FIG. 22.

In this embodiment, for setting the anchor plate in form of several concrete discs, no expensive crane ship is required. This saves substantial installation costs and increases, thereby, the usage/cost factor and, thereby, it is an important portion of the overall cost-effectiveness.

In total, inexhaustible, pronounced environment-friendly kind of energy retrieval with a high degree of efficiency is provided by using the force of waves.

### LIST OF REFERENCE SIGNS

10 wave power generator unit 12 drill rod
14 floatable buoy 14a floatable buoy cover
14b floatable buoy body
16 flywheel
18 generator (below/inside)
20 spring column
22 anchor plate (below/outside)
24 worm spring
26 fixing ring (above/inside)
28 cable
30 seal (above/outside)
32 free wheeling gear unit
34 sealing hub
36 Styropor envelop
38 anchoring rod
38b central rod
40 upper tension rod
42 central tension rod
44 adjustment float
46 tension rod housing
48 spring housing
50 adjustment plate
52 bottom plate
54 interior housing
56 body connection
60 gear teeth of flywheel
62 gear cover
64 bell-shaped claw
66 catching cams
68a roller bearing/ball bearing
68b roller bearing/ball bearing
68c roller bearing/ball bearing
68d roller bearing/ball bearing
70 signal light
72 air valve
74 insulation layer
76 cylindrical float
78a concrete bed
78b v-shaped wall
80 distance rollers
82 flow opening
84 cut out
86 metal ring
88 guide groove
90 coastal power station housing
90a coastal power station housing cover
90b coastal power station body
91 battery
100 wave/swell 110 spring block
112 extension limiting means
114 spring block bottom
116 first intermediate plate
118 second intermediate plate
120 spring block cover plate
122 spring
122a first spring pair
122b second spring pair
122c third spring pair
124 central rod

1-19. (canceled)

20. A device for generating electricity from the force of waves, comprising:
a first floating component,
a second stationary component,
a generator,
a translational element,
a rotational element,
said first floating component and said second stationary component are adapted to be translationally moved relative to each other by said waves causing a translational relative movement between said translational element and said rotational element, and,
said at rotational element absorbs rotational energy which is converted into electricity by said at least one generator.

21. A device according to claim 20, wherein a gear unit is interposed between said translational element and said rotational element.

22. A device according to claim 21, wherein said gear unit is a free wheeling gear unit.

23. A device according to claim 20, wherein said translational element is connected to said stationary component, and said rotational element is connected to said floating component.

24. A device according to claim 20, wherein said rotational element is connected to said stationary component, and said translational element is connected to said floating component.

25. A device according to claim 20, wherein said stationary component and/or said floating component consists of two parts.

26. A device according to claim 20, wherein said rotational element is in operational relationship with the rotor of the generator.

27. A device according to claim 20, wherein a dampening element is provided which is in operational relationship with said floating component and with said stationary component.

28. A device according to claim 20, wherein a resetting element is provided which is in operational relationship with said floating component and said stationary component.

29. A device according to claim 20, wherein:
a dampening element is provided which is in operational relationship with said floating component and with said stationary component;
at least one resetting element is provided which is in operational relationship with said floating component and said stationary component; and,
said dampening element and said resetting element form a constructional unit.

30. A device according to claim 20, wherein a step-up gear unit is provided between said translational element and said generator.

31. A device according to claim 20, wherein said translational element is a drill rod and said rotational element is a flywheel, said flywheel rotates when said flywheel moves relative to said drill rod.

32. A device according to claim 22, wherein said free wheeling unit is a claw coupling.

33. A device according to claim 20, wherein said stationary component is an anchor plate.

34. A device according to claim 20, wherein said floating component is a floatable buoy.

35. A device according to claim 20, wherein a spring is provided in operative relationship with said floating component as well as with said stationary component.

36. A device according to claim 20, wherein said stationary component is a coastal power station housing and is connected to the coastal ground.

37. A device according to claim 36, wherein said coastal power station housing is generally cylindrically shaped.

38. A device according to claim 37, wherein said coastal power station housing is concrete.

39. A device according to claim 37, wherein said coastal power station housing is metal.
